(19) United States
(12) Patent Application Publication
(10) Pub. No.: US 2017/0339855 A1
(43) Pub. Date: Nov. 30, 2017

(54) Horticulture Grow Pipe Apparatus for Growing Plants

(71) Applicant: Jouni Birger Spets, Vantaa (FI)

(72) Inventor: Jouni Birger Spets, Vantaa (FI)

(21) Appl. No.: 15/533,379

(22) PCT Filed: Oct. 20, 2015
(86) PCT No.: PCT/FI2015/050712

§ 371 Date: Jun. 6, 2017

(30) Foreign Application Priority Data
Jan. 23, 2015 (FI) 20150025
Mar. 3, 2015 (FI) 20150059

(51) Int. Cl. A01G 31/06; A01G 7/04; A01G 31/00

(52) U.S. Cl. CPC A01G 31/06; A01G 7/045; A01G 2031/006

(57) ABSTRACT

The embodiments of the invention relates generally to horticulture; growing plants, flowers, fruits, vegetables, herbs and green plants, and more specifically it relates to growing plants with vertically oriented hydroponic garden. The embodiment of invention is a horticulture grow pipe apparatus made in one piece, having one or more horizontal pipe section with plant entrance places (3), where plant roots go inside to the grow pipe body and get exposed to nutrient and oxygen rich water flowing inside the pipe. In one end of the top horizontal pipe section is upper pipe connection with upper pipe end (1) for water inbound to pipe, and in other end of the lowest horizontal pipe section pipe turns downwards to lower vertical pipe section (4) and ends with lower pipe end (2), what is the water exit from pipe. Grow pipe body can have fastening points (11) for system mounting.

The percent invention is Continuation-In-Part of Finnish patent application No. 20150059 named: Pystysuuntainen kasvien kasvatusjärjestelmä and filed Mar. 3, 2015, which in turn is Continuation-In-Part of Finnish patent application No. 20150025 named: Kasvien kasvatusjärjestelmä and filed Jan. 1, 2015.

### FIELD OF THE INVENTION

The embodiments of the invention relates generally to horticulture; growing plants, flowers, fruits, vegetables, herbs and green plants in growing systems, and more specifically it relates to vertical hydroponic gardening; growing plants with water and nutrients in vertically oriented garden.

### BACKROUND OF THE INVENTION

Green walls and vertical gardens have been developed for years around the world. Idea is to lift plants growing on the inside and outside walls.

In general, the construction of large green walls is currently mainly done by specialize companies that are constructing plant walls to company premises, lobbies and shopping centers, restaurants, hotels etc. businesses and to some households.

Vertical grow systems based on organic soil on overlapping containers have significant weight and water resistance demands and large commercial green walls and vertical growing systems come typically with building projects tailored for individual user cases and have considerable complexity and high purchase cost. Such a systems have typically also separate irrigation systems usually consisting of several parts; tubes, nozzles, connectors, and water insulation layers and grow material layers. Due to high costs, the construction of green walls have been possible mainly for companies.

Some ready-made water-based hydroponics systems for green walls exist, but typically they are small scale wall element solutions not planned to cover whole walls. They are usually also technically complex and expensive solutions. These systems typically have solid back wall so they cannot be used in front of a window, so that both plants and room would get sun light from the window. Examples of this kind kind-of systems are inventions US 20130160363 A1 and US2014000163 A1.

The green walls based on hydroponics, water cultivation, can be lighter build than systems based on soil. In hydroponics growing system nutrient and oxygen rich, flowing water is routed to plant roots continuously or at intervals and typically plants grow much faster in hydroponics system than with soil systems. Some vertical hydroponic grow systems have been built from generic plastic tubes and connection parts with do-it-yourself principle. Typically these systems are based on combination of circular sewer and water tubes and separate connective tube joints, acquired from local hardware store. Example of such a system is an American invention (US2011067301 A1). A clear problem with these systems is that the dimensions and shapes of these general tubes are not planned for gardening and plant growing purposes and for example the round tube bottom of circular tube directs water flow typically below net pots, so leaving young plant roots inside the net pots without water. The need to use various different tubes and tube connectors also increases the complexity and cost of building such a systems. The more the system uses separate tubes and connectors the more difficult it is to build it and to have any structural support from system itself, and also the possibility of water leakage increases with many joints in the system.

From the known commercial vertical and modular hydroponic growing systems the Tower-garden (www.towergarden.com) is the most developed, but it is not designed to be used with wall and window structures, but rather outside and greenhouse conditions were rotating sun or wide grow light system can reach all the plants growing around vertical pillar of the system.

There are no known commercial applications with simple technical solution solving the building of vertical hydroponic gardens for both walls and windows in easy and cost efficient way.

### SUMMARY OF THE INVENTION

The present invention targets is to solve designing and building of vertical grow system with new and innovative grow product and hydroponics system.

The basic idea of the present horticultural invention is a modular, tubular and hollow grow pipe apparatus made in one body piece and having special, portable and durable body shape and characteristics. The invented grow pipe apparatus with innovative step-like shape, up-wards going functionality and modular design structure, gives new possibilities for designing and building small or big vertical hydroponic green walls and vertical gardens in multiple sizes and shapes.

The embodiment of present invention; horticulture grow pipe apparatus, is also referred as grow pipe or pipe with this document.

The embodiment of invention is the grow pipe apparatus having one or more vertical pipe sections and grow pipe apparatus having one or more horizontal pipe sections. All horizontal pipe sections have one or more entrance places for plant, where plant roots go inside to the grow pipe body. In one end of the top horizontal pipe section pipe typically turns upwards, with sharp turn or with round turn, and pipe ends with upper pipe connection and upper pipe end. In other end of top horizontal pipe section pipe turns downward;
with sharp or round turn to lowest vertical pipe section and then ends with lowest pipe end, or
when grow pipe has more than one horizontal pipe sections, pipe turns with sharp or round turn to lower vertical pipe section, and then turns with sharp or round turn to next horizontal pipe section, below top horizontal pipe section. By following grow pipe body downward this way, one can finally reach lowest horizontal pipe section and lowest vertical pipe section and grow pipe then ends with lowest pipe end.

At the top surface of horizontal pipe section there are plant entrance places, where plant roots are put into the grow pipe body, with or without net pot's, so that plant roots can touch the water flowing inside the tube. It is typical for grow pipe, that at plant entrance places the bottom profile of grow pipe is flat. Flat pipe bottom at plant entrance places makes it easier for plant roots in net pots to reach flowing water inside the pipe. Flat pipe bottom also supports net pots. For some design, manufacturing or functionality reasons it is possible that pipe bottom profile, bottom surface can be also rounded, curved or other way shaped at plant entrance places.

When growing plants in grow pipe hydroponically, the nutrient rich water is first routed into top grow pipe's upper end. Inside the pipe water flows down freely by gravity pull, through vertical and horizontal pipe sections, finally reaching lowest vertical pipe section and then exiting grow pipe from lower pipe end. Typically water is then going to water tank. From water tank water is moved with water pump or with help of air-pump back to top grow pipe's upper end. Hydroponic grow system with grow pipes runs typically nutrient and oxygen rich flowing water in closed circuit: water tank—water pump—water rise tube—upper end and upper connection of top grow pipe—downwards inside vertical and horizontal sections of grow pipe body—lowest pipe end—water tank.

From the multiple embodiments the grow pipe body can have, the basic and simplest embodiment is in one piece made grow pipe apparatus having; one horizontal pipe section with plant places, one upper pipe connection with upper pipe end, starting at one end of the said horizontal pipe section, and one lower vertical pipe section ending to lower pipe, starting at other end of said horizontal pipe section.

Typically lower pipe end, upper pipe end and upper pipe connection are dimensioned is such a way, that when several grow pipes are assembled, the first pipe's upper connection is “female” counterpart for next grow pipes lower pipe end going inside first pipe's upper connection as “male” counterpart. Connection is typically water tight connections for non-pressure grow pipes. By connecting several grow pipes it is possible to assemble several layers high pipeline for vertical garden. Named layers are referring to horizontal pipe sections.

One embodiment of the invention is in one piece made grow pipe apparatus having several horizontal pipe sections, all of them having plant entrance places, and grow pipe also having several vertical pipe sections, and with upper pipe connection starting at one end of top horizontal pipe section and at other end of lowest horizontal pipe section starts lowest vertical pipe section ending with lower pipe end. Also this grow pipe embodiment has modular design and lower pipe and can be connected inside upper pipe end of other identical or similar grow pipe.

Grow pipe is usually made of plastic in one piece, and it has round, oval, rectangular, square or other type pipe diameter, which can change in different areas of the grow pipe body.

Vertical hydroponic grow system made of grow pipes can be much lighter in weight than systems based on soil and its construction does not need significant support structures. System can be mounted on a wall, in front of a window or as partition wall by using simple frame, roof hanging wires with separate fasteners or by using ready-made fastening points on grow pipe body. Connected grow pipes are forming pipeline witch is typically going directly up with steps or upward with sidesteps on wall or window.

Grow pipes can be also assembled around pillar by grow pipe making corkscrew type form with up-going plant steps rising around pillar body. It is also possible to have self-standing grow pipe system by water tank having special connection interface for lower pipe end, in bottom of the system.

Some more benefits of the system:
Vertical multi-layer grow pipe system has see-through structure and it can be put on window sun so that both plants and room get sun light.
Vertical wall garden is space-effective, plants need much less floor space with vertical garden structure than with normal horizontal garden.
Plants living in system cleanse and moisturize the air effectively.
System can be used for food growing.

More alternative embodiments of the invention are described in detail description part of the document.

### BRIEF DESCRIPTION OF THE DRAWINGS

FIG. 1A, illustrates front profile of one basic version of horticulture grow pipe apparatus, in one piece made grow pipe apparatus having; plant entrance places (3) at horizontal pipe section (8), and at one end of horizontal pipe section pipe turns downward with round turn to lower vertical pipe section (4), and ends with lower pipe end (2), and in the other end of horizontal pipe section pipe turns upward with round turn to upper pipe connection, and the said upper pipe connection being upward (5) kind of connection type and grow pipe then ends with upper pipe end (1). Lower pipe end (2) is dimensioned in a such way that it can be inserted inside upper pipe end (1) and upward (5) connection of other grow pipe.

FIG. 1B, illustrates one basic version of grow pipe, in one piece made grow pipe apparatus having; plant entrance places (3) at horizontal pipe section (8), and at one end of horizontal pipe section pipe turns downward with sharp turn to lower vertical pipe section (4), and ends with lower pipe end (2), and in the other end of horizontal pipe section pipe turns upward with sharp turn to upper pipe connection, and said upper pipe connection being upward (5) kind of connection type and grow pipe then ending with upper pipe end (1). Lower pipe end (2) is dimensioned in a such way that it can be interested inside upper pipe end (1) and upward (5) connection of other grow pipe.

FIG. 1C illustrates grow pipe version similar to FIG. 1A, but here upper pipe connection is turning inward (6) to horizontal pipe section.

FIG. 1D, illustrates grow pipe version similar to FIG. 1A, but here upper pipe connection is open (7) kind of connection type, an open hole on top surface of the horizontal pipe section.

FIG. 1E, is 3D illustration of one kind of grow pipe design version where upper pipe connection is turning upward (5), pipe turns are being round turns and pipe body having attachment points (11) for mounting the pipe to wall, frame etc.

FIG. 1F , is same illustration as FIG. 1D but this illustration is taken from lower angle and showing also attachment points (12) for grow lights on pipe body.

FIG. 2A, is illustration from top view of FIG. 1A showing horizontal pipe section (8) with plant entrance places (3) being round.

FIG. 2B, is illustration from top view of FIG. 1B showing horizontal pipe section (8) with plant entrance places (3) being square and suitable for rock-wool-cubes and square net pots.

FIG. 3, is cross-sectional view from FIG. 1A showing upper vertical pipe section (21) with upper pipe connection being upward (5) type of connection.

FIG. 4, is cross-sectional view from FIG. 1A showing grow pipe's plant entrance places (3) with flat pipe bottom (9).

FIG. 5, is cross-sectional view from FIG. 1C showing upper pipe connection having inward (6) kind of connection type where upper vertical pipe section and upper pipe connection are turning inside into grow pipe's body from top surface of horizontal pipe section, and ending with upper pipe end (1).

FIG. 6, is cross-sectional view from FIG. 1D showing upper pipe connection being open (7) type of connection with upper pipe end (1).

FIG. 7, illustrates one assembly of four grow pipes all having one horizontal pipe section, according to grow pipe embodiment version shown with FIG. 1A, connected to each other at upper and lower pipe ends, so forming pipeline (15) with four horizontal pipe sections (8).

FIG. 8, illustrates one assembly of five grow pipes all having different kind of body form designs. With three lower grow pipes in illustration, the horizontal and the vertical pipe sections of each pipes are united with sharp pipe turns. With two upper grow pipes in illustration, the horizontal and the vertical pipe sections of both pipes are united with round pipe turns. Grow pipes are connected to each other with lower pipe end and upper pipe end connections, so forming pipeline (15) with five horizontal pipe sections (8).

FIG. 9, illustrates one type of grow pipe apparatus made in one peace with integrated water rise tube (13) and with top horizontal pipe section and lower horizontal pipe section being united with vertical pipe section (20).

FIG. 10, illustrates partly cross-sectional view from FIG. 9 showing the upper pipe connection of the grow pipe apparatus having connection channel (14) from integrated water rise tube (13) to inside of upper pipe connection (5).

FIG. 11, illustrates one type of horticulture grow pipe apparatus system. A pipeline made in one piece, with four horizontal pipe sections (8), and with three vertical pipe sections (20) between top horizontal and lowest horizontal pipe sections, and with integrated water rise tube (13) on pipeline body. Under the pipeline is water pump (16) in water tank (17) connected to water rise tube (13) with connective tube (18).

FIG. 12, illustrates one type of horticulture grow pipe apparatus system. A pipeline assembly with four horizontal pipe sections (8) being four overlapping grow layers for plants. Non-integrated water rise tube (19) is going from water pump (16) to top of the pipeline inside or outside the grow pipe body, ending inside the upper pipe connection (5).

FIG. 13, illustrates one type of horticulture grow pipe apparatus system forming a letter D shape when plants are on the system. The system is constructed with two different kinds of multi-layer pipeline (15) structures; one made from eight connected grow pipes, each with one horizontal pipe sections and non-integrated water rise tube (19), and other pipeline structure is made by connecting together two separate pipelines both having four horizontal pipe sections and integrated water rise tube (13). Both pipeline structures have water rise tubes (13, 19) connected to upper pipe ends (5) and they are getting water by water pump (16) from water tank (17) under the system.

FIG. 14, illustrates one type of horticulture grow pipe apparatus system. A pipeline design forming a tree like shape with grow pipes being the branches of the tree. The grow pipe branches are connected with generic tube connections to tree's body made from generic water tube.

### DETAIL DESCRIPTION OF PREFERED EMBODIMENTS OF THE INVENTION

The typical embodiment of present invention is grow pipe apparatus having one or more vertical pipe sections and grow pipe apparatus having one or more horizontal pipe section (8) all with one or more plant entrance places (3), and at one end of top horizontal pipe section starts top vertical pipe section with upper pipe connection being upward (5), inward (6) or open (7) type of connection, and then pipe ends with upper pipe end (1), and in the other end of lowest horizontal pipe section pipe turns downwards to lowest vertical pipe section (4) with sharp or round turn, and grow pipe then ends with lower pipe end (2). Lower pipe end (2) is dimensioned in a such way that it can be inserted inside upper pipe end (1).

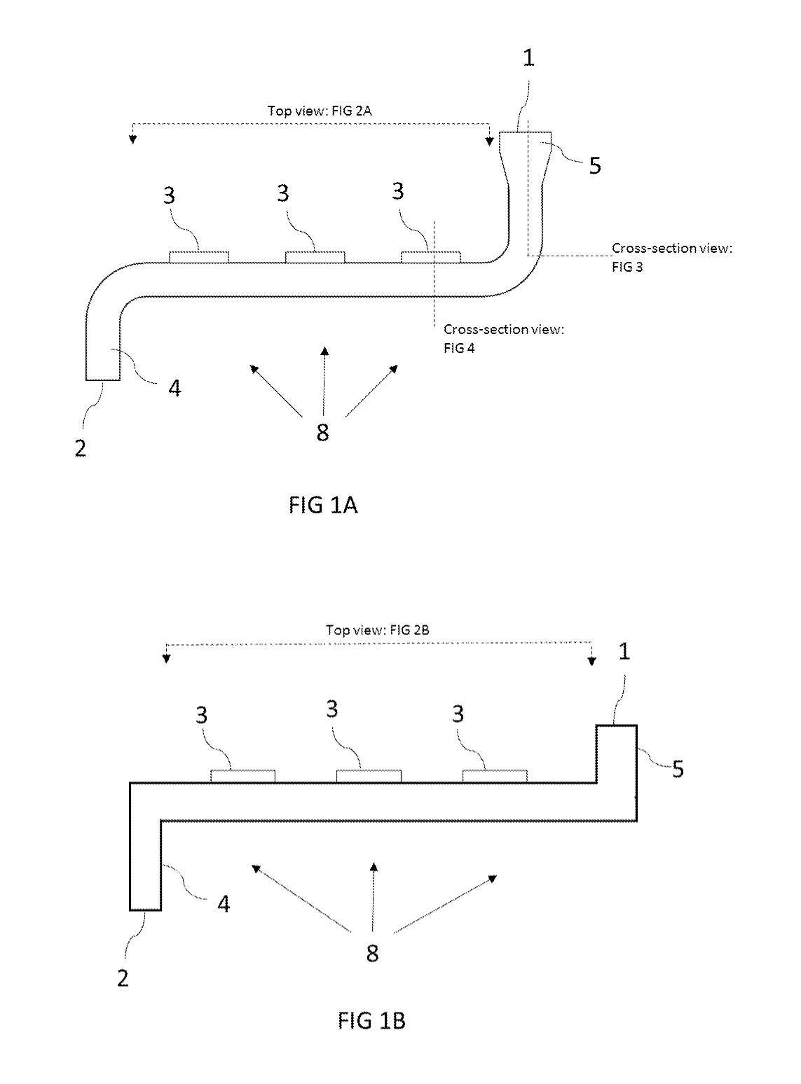

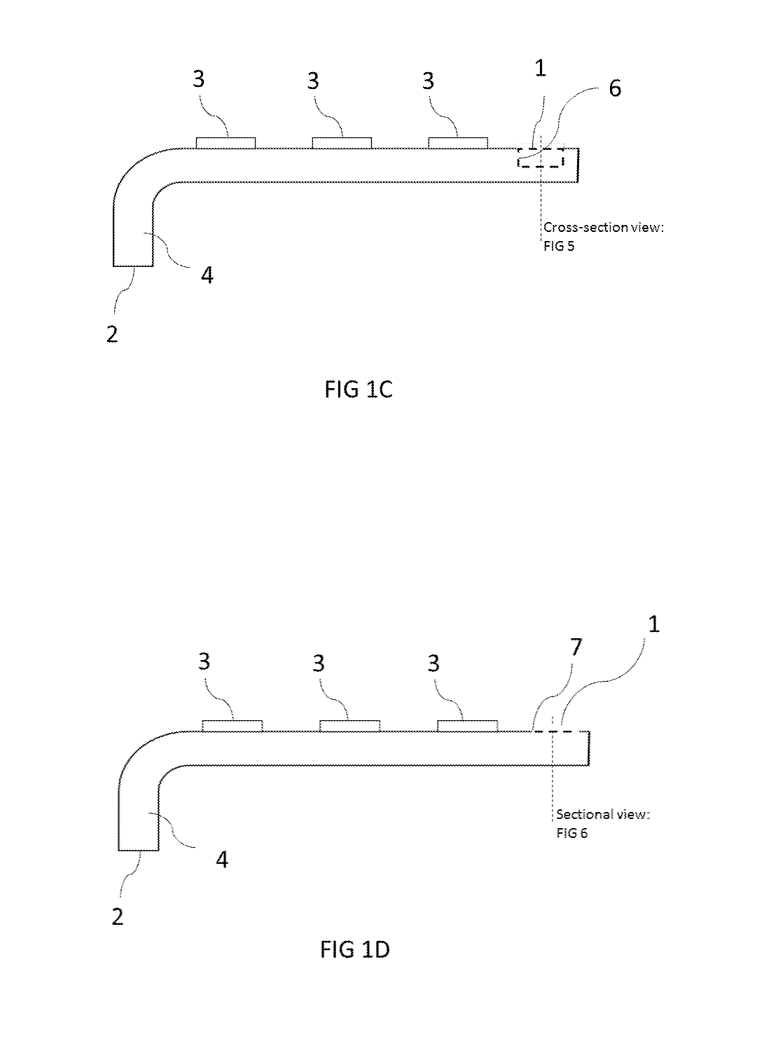

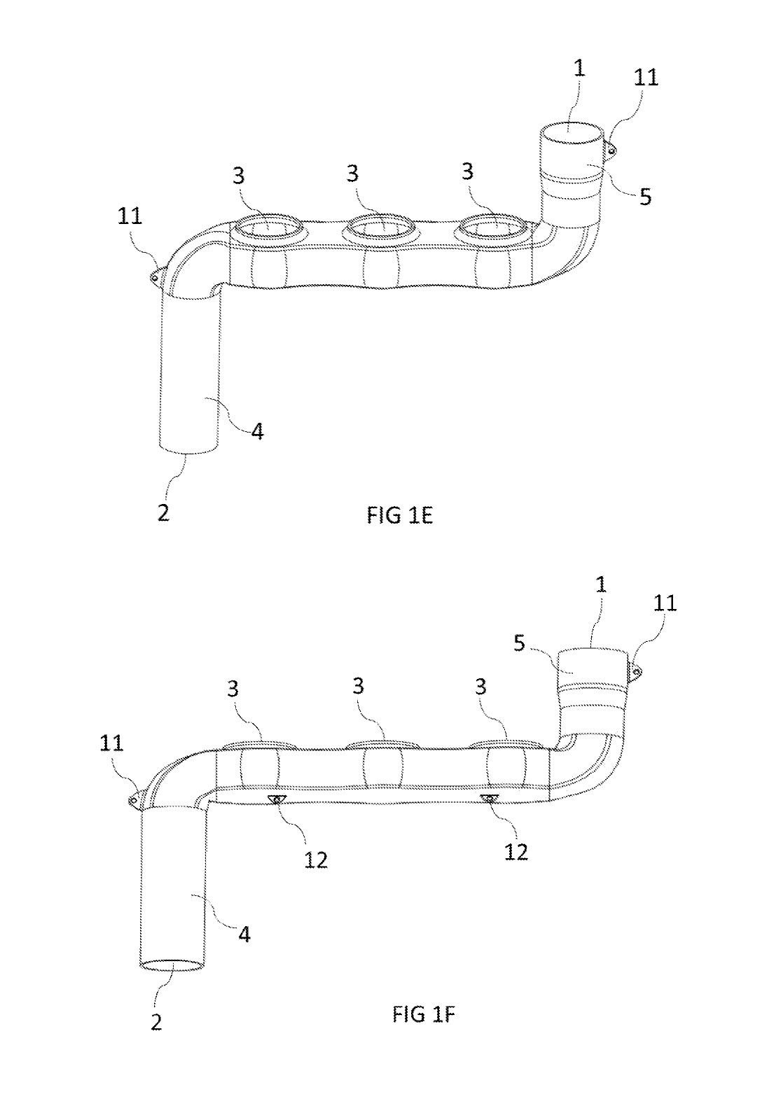

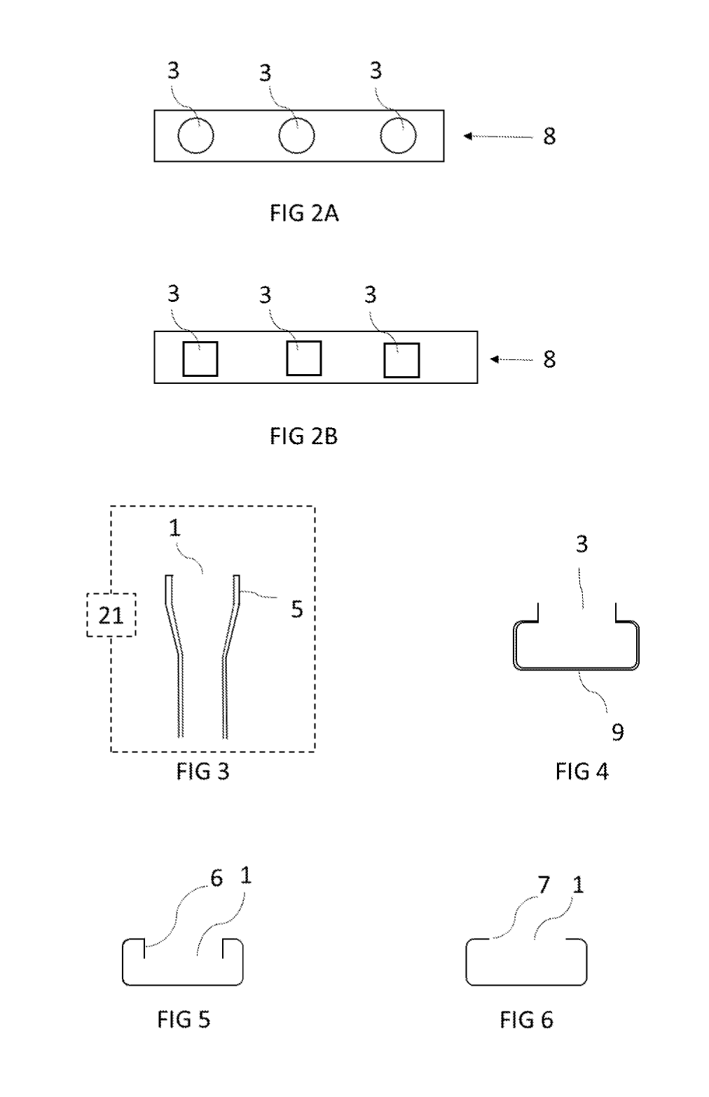

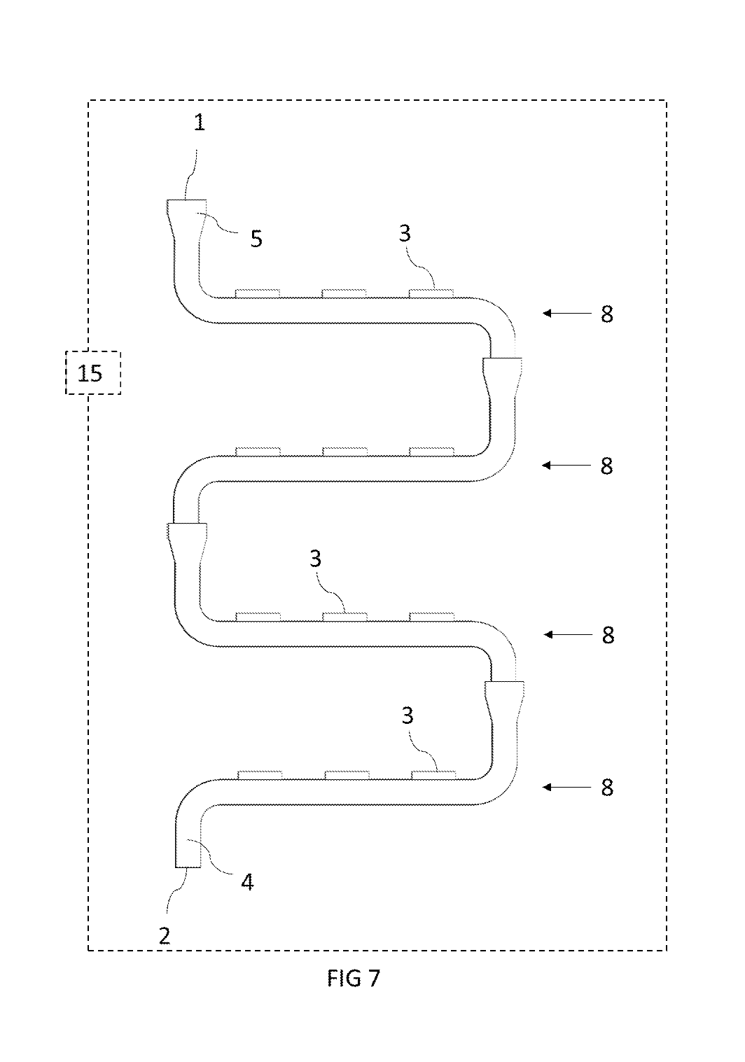

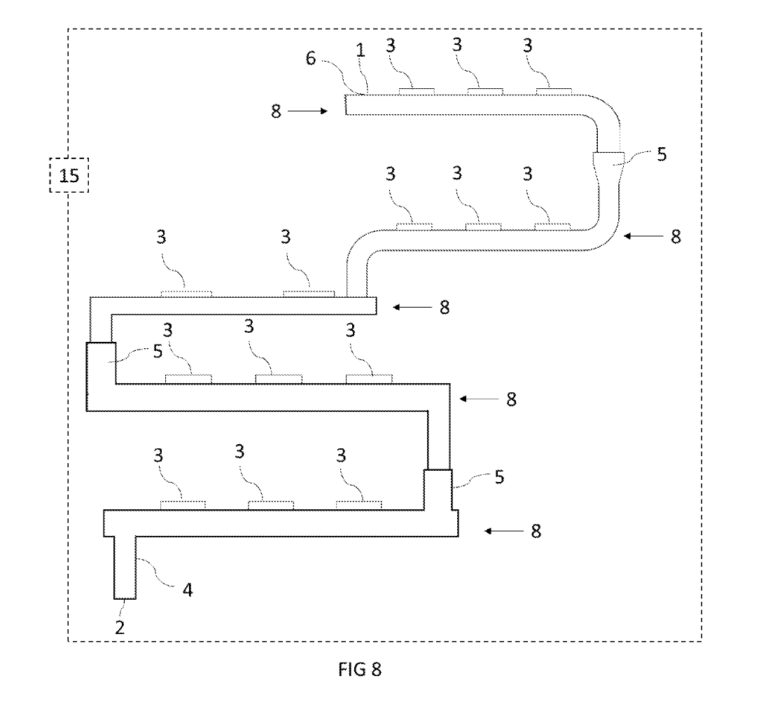

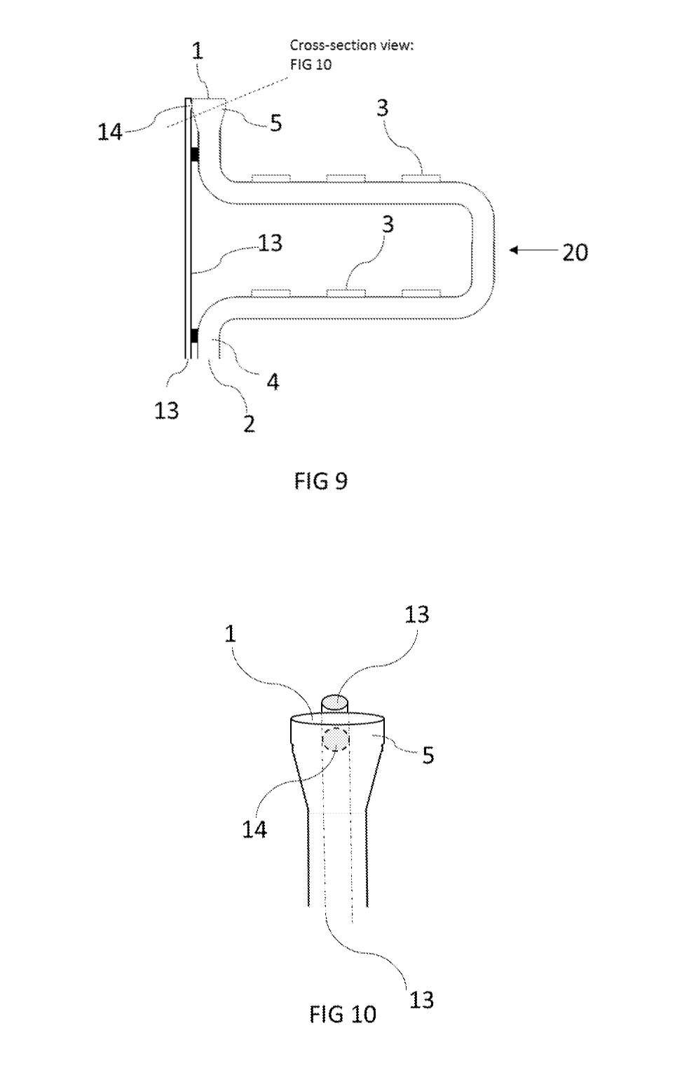

One basic and most preferred embodiment of invention is grow pipe apparatus with the upper pipe connection being upward (5) type of connection, like in FIG. 1A, FIG. 1B and FIG. 3 show. Upward type of connection means that in the one end of the top horizontal pipe section pipe turns upwards, to vertical direction with sharp turn or with round turn, ending with upper pipe connection and upper pipe end (1). Upward (5) type of connection is female type connection, where lower pipe end (2) of one pipe goes inside upper connection of another pipe. Upward (5) type of connection is preferred connection type for grow pipes because it has the best structural support and water holding capabilities.

Upper pipe connection with inward (6) type of connection, like shown with FIG. 1B and FIG. 5, means that in one end of the top horizontal pipe section the upper pipe connection and upper vertical pipe section are turning inside the horizontal pipe section and then ending with upper pipe end (1). Inward (6) type of connection is female type connection, where lower pipe end (2) of one pipe goes inside upper connection of another pipe.

Upper pipe connection with open (7) type of pipe connection, like shown with FIG. 1C and FIG. 6, means that in one end of the top horizontal pipe section is upper pipe connection with open connection hole on the top surface of horizontal pipe sections, the hole and hole edges both being upper pipe connection (7) and the upper pipe end (1) of the grow pipe. Open (7) type of upper connection is female type of connection, where lower pipe end (2) of one pipe goes inside upper connection of another pipe.

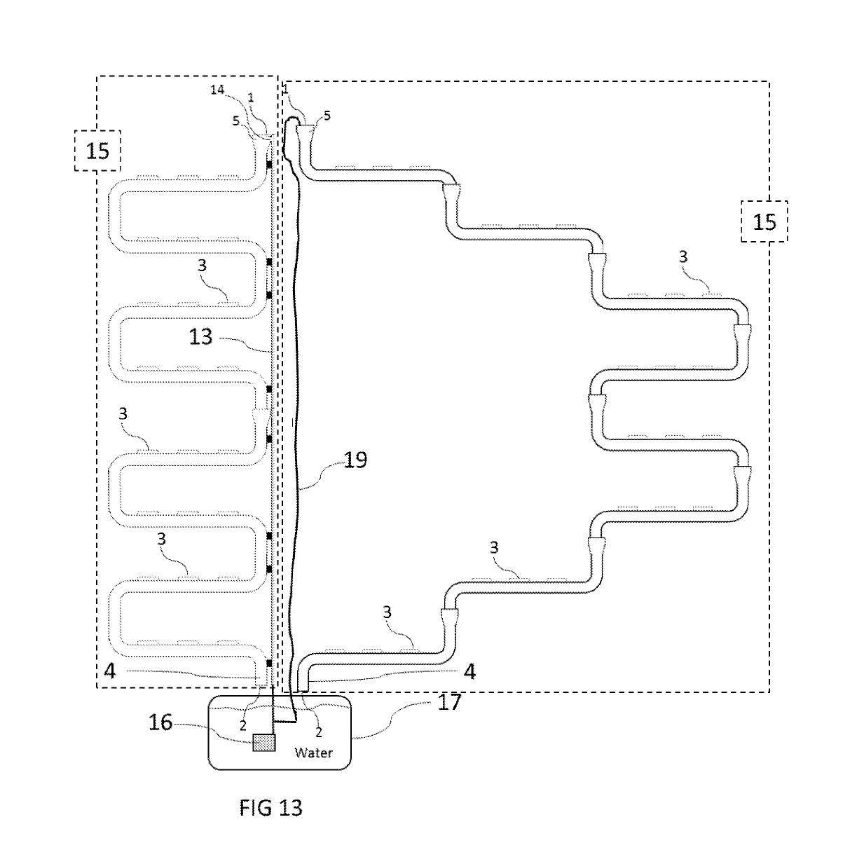

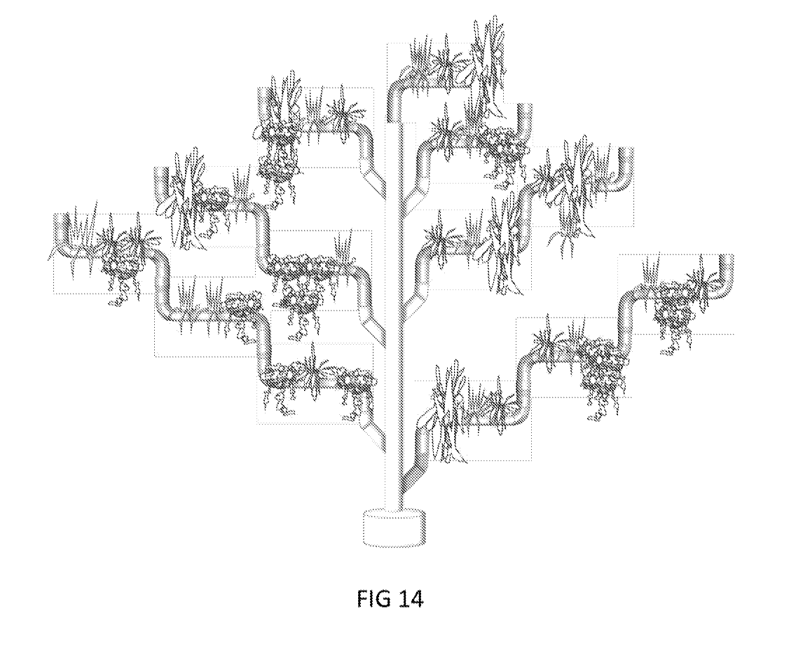

All the upper pipe connection types described above here are dimensioned in such a way that the lower end (2) of one grow pipe can be inserted inside the upper end (1) of another grow pipe. This way it is possible to connect several grow pipes and assemble multi-layer pipeline (15), like with FIG. 7, FIG. 8 and FIG. 13.

At the top surface of horizontal pipe section (8) are one or several plant entrance places (3). It is typical for grow pipe's cross-sectional shape, that at plant entrance places the pipe bottom profile (9) is flat, like shown with FIG. 4.

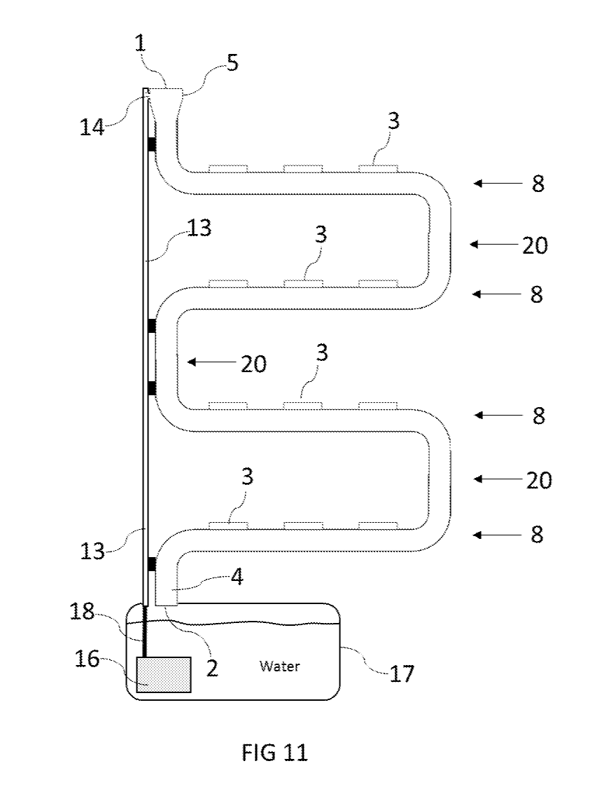

One typical example of inventions embodiment is the horticulture grow pipe apparatus system with hydroponics watering method, shown with FIG. 11. In one piece made grow pipeline having four horizontal pipe sections (8) and integrated water rise tube (13). Nutrient rich water from water tank (17) is pumped by water pump (16) to connective tube (18) and from there to water rise tube (13) and from there to connective channel (14) and from there to upper connection (5) of top grow pipe, and from where water can freely flow downwards inside the grow pipe body, while feeding plant roots coming into pipe from plant entrance places (3) on horizontal pipe section (8) and when water returns to water tank (17) from the lower pipe end (2) the water flow loop is closed.

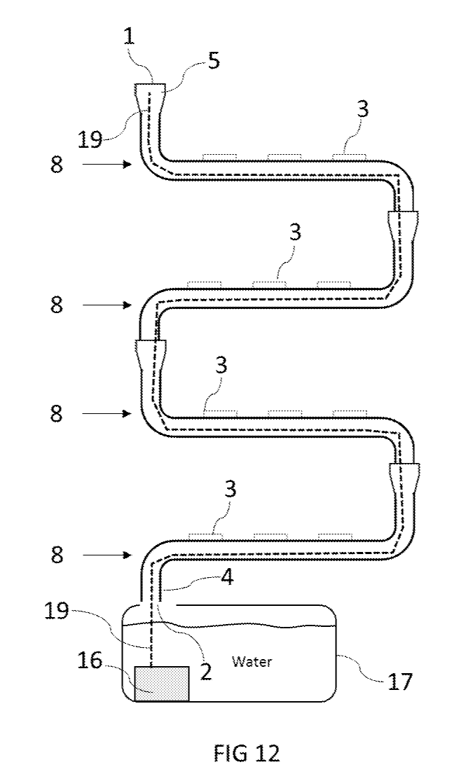

Second typical example of inventions embodiment is the horticulture grow pipe apparatus system with hydroponics watering method as shown with FIG. 12. In system four grow pipes are connected to each other with upper end—lower end connection, so forming four layer pipeline with water tank being under the lowest pipe end (2). Nutrient rich water at water tank (17) is pumped by water pump (16) to non-integrated water rise tube (19) and from there to upper connection (5) of top grow pipe, from where water can then freely flow downwards inside the grow pipe, while feeding plant roots coming to pipe from plant entrance places (3) on horizontal pipe sections (8) and water then finally returning to water tank (17) from the lower end of the pipe (2). Water rise tube (19) can go to upper end (1) of pipeline inside or outside the grow pipe body, but it has to end inside the top grow pipe body.

Some more characteristics and alternative embodiments for the invented grow pipe apparatus and system:
The lower pipe end of grow pipe can be connected to upper pipe end of another identical or similar grow pipe with compatible connection type. Preferred connection type is upper connection being upward (5) type of connection on top horizontal pipe level and upper pipe connection being female counterpart for lower pipe end going inside upper pipe end as male counterpart.
Grow pipe's upper pipe connection and lowest vertical pipe section can be made with threads, thus connection works like bolt and female screw type of connection. Connection can be hosted also with additional add-on parts when needed for design or functional reasons.
Typically the lower and upper pipe end are formed in that way (example: round pipe ends and round upper connection) that grow pipes can rotate 360 degree on horizontal level around the active connection.
The plant entrance places are normally on top surface of horizontal pipe sections, but in some embodiment of invention plant places can be also somewhat on side of horizontal pipe section and also within vertical pipe sections.
Plant entrance places on pipe body can be with or without collars around plant entrance places.
Depending on user cases the plant entrance places are designed to be filled with plants or plans with pots, net pots, rock wool cubes in different shapes and sizes. Pipe, pots and net pots can be filled with non-organic or organic grow materials for supporting plant roots.
Grow pipe is designed for hydroponics cultivation, but it can be used also for soil and aeroponic cultivation.
Also aquaponics can be used with grow pipe system, meaning that water tank is also a fish aquarium and fish waste in water feeds the plants in the system.
The water flowing inside the grow pipe body can be routed with inner pipe surface shapes to make water flow evenly and silently.
The sound coming from water flowing inside the pipe body can be absorbed with screw, spiral or other way shaped apparatus put inside the vertical pipe section.
The exact grow pipe size and shape; diameter, weight, width, height and length can vary according to the use cases and production techniques.
The horizontal pipe section does not have to be on horizontal 0 degree spirit level, but it is even better for water flow that each horizontal pipe section has some tilt from upper pipe end towards the lower pipe end.
Vertical pipe section does not have to be on vertical line with exact 90 degree angle compared to horizontal pipe section, but it is important that water can flow freely with gravity pull from top horizontal pipe section to lowest vertical pipe section through all horizontal and vertical pipe sections and then exiting from lower pipe end.
The maximum height of the horticulture grow pipe apparatus system is limited by water pump or air-pump capacity to lift water from water tank to upper pipe end of the top grow pipe.

Grow pipe can be made with attachment points for fastening the grow pipe easily to any surface like wall, rack, frame, pillar, hanging wire or to other supportive structures.

The grow pipe can be made with attachment points for grow lights and water raise tube.

Grow pipe surface texturing can be plane or with shapes from nature, geometry and art, and they can vary depending on manufacturing technique and user cases.

The grow pipe can be hosted with water wheels and other devices which utilize the kinetic energy of flowing water inside the pipe. Water wheel with axel penetrating grow pipe's wall in vertical pipe section could move object and even generate energy for LED-light etc.

Grow pipe's upper pipe connection with upper pipe end and lowest vertical pipe section with lower pipe end can be all shaped and dimensioned in a such way that they can be connected to each other, but also with generic water tubes and tube connectors.

For some user cases grow pipe's upper and lower pipe ends can be made also with pipe collars, but typically then connections between grow pipes have to be hosted with gaskets and fasteners.

The grow pipe can be colored in all colors, but it should not be made from transparent materials. The light entering inside the grow pipe body can causes algae growth and the plant roots should not be exposed to light.

The grow pipe is made in one piece and produced from durable, weather resistant materials such as PE, HDPE, LDPE, PP and PVC plastic, aluminum, steel, stainless steel, copper, carbon fiber, glass fiber, glass, rock, rubber or silicone. Suitable production techniques with plastics are for example pressure molding, blow molding, 3D printing, rotational molding, heat molding and extrusion technology, plastic welding, gluing and some combinations of these, depending on the required grow pipe features, dimensions and production volumes.

The above description of illustrated embodiments of invented horticulture grow pipe apparatus is not intended to be exhaustive or to limit the embodiments to the precise form, structure or production method or use case disclosed. While specific embodiments of, and examples for, the grow pipe are described herein for illustrative purposes, various equivalent modifications are possible within the scope of the described embodiments, as those skilled in the relevant art will recognize. The elements and functions of various embodiments described above can be combined to provide further embodiments. All such modifications are intended to be included within the true spirit and scope of this patent application.

In general, in any following claims, the terms used should not be constructed to limit the described system to the specific embodiments disclosed in the specification and the claims, but should be constructed to include all possible grow pipe body forms, operations or process that operate under the claims.

What is claimed,:

1. A horticulture grow pipe apparatus with hollow body and tubular structure, made for growing plants, flowers, herbs, rice, fruits, vegetables and green plants, comprising;
made in one piece,
having one or more vertical pipe sections,
having one or more horizontal (8) pipe section, all with one or more plant entrance places (3),
in one end of the lowest horizontal pipe section pipe turns downwards with sharp or round turn to lowest vertical pipe section (4) and pipe then ends at lower pipe end (2),
in other end of the top horizontal pipe section is the upper pipe connection and upper pipe end (1), and said upper pipe connection has alternative connection types,
said lower pipe end (2) is dimensioned in a such way that it can be inserted inside to upper pipe connection and upper pipe end (1) of another grow pipe.

2. The horticulture grow pipe apparatus according to claim 1, wherein the alternative connection types for upper pipe connection are;
more preferably upward (5) type of connection, where grow pipe body makes sharp or round upward turn from the top horizontal pipe section to upper vertical pipe section (21) and ends with upper pipe connection and upper pipe end (1),
inward (6) type of connection, where the upper vertical pipe section and the upper pipe connection are turning inside the grow pipe body from top surface of horizontal pipe section,
open (7) type of connection with open hole on top surface of horizontal pipe section.

3. The horticulture grow pipe apparatus according to claim 1 or 2, wherein upper pipe connection or lowest vertical pipe section (4) are with threads for connection.

4. The horticulture grow pipe apparatus according to any of claims 1-3, wherein on the horizontal pipe section (8) at the plant entrance places (3) the grow pipe bottom (9) shape is flat.

5. The horticulture grow pipe apparatus according to any of claims 1-4, wherein the grow pipe body has fastening points (11) for mounting.

6. The horticulture grow pipe apparatus according to any of claims 1-5, wherein the grow pipe body has fastening points (12) for connecting grow lamps and water rise tube.

7. The horticulture grow pipe apparatus according to any of claims 1-6, wherein the water rise tube (13) is integrated with the grow pipe body.

8. The horticulture grow pipe apparatus according to any of claims 1-7, wherein the water rise tube is connected to upper pipe connection with connective channel (14).

9. The horticulture grow pipe apparatus system comprising; a combination of several horticulture grow pipe apparatus, according to any of claims 1-8, are forming a pipeline (15) structure when several horticulture grow pipe apparatus are connected together by inserting lower pipe end (2) of one grow pipe into upper pipe end (1) of another grow pipe.

10. The horticulture grow pipe apparatus system according to claim 9, further comprising; hydroponic watering method for said system with a water pump (16) lifting nutrient rich water from water tank (17) to water rise tube, to upper pipe end (1) of the top grow pipe, and from said upper pipe end water can freely flow downwards inside the grow pipe body, so feeding plant roots entering inside the grow pipe body at plant entrance places (3), and water then returning to water tank (8) from lower pipe end (2) thus closing the water flow loop.
